(19) United States
(12) Patent Application Publication
(10) Pub. No.: US 2007/0079516 A1
(43) Pub. Date: Apr. 12, 2007

(54) Device for marking a straight line

(76) Inventors: Patrick J. Eckstein, Brookville, IN (US); Rebecca M. Eckstein, Brookville, IN (US)

Correspondence Address: JAMES RAY & ASSOCIATES, 2640 PITCAIRN ROAD, MONROEVILLE, PA, 15146, US

(21) Appl. No.: 11/544,852

(22) Filed: Oct. 6, 2006

Related U.S. Application Data
(60) Provisional application No. 60/724,488, filed on Oct. 7, 2005.

(51) Int. Cl. G01C 15/00

(52) U.S. Cl. 33/286

(57) ABSTRACT

The invention provides a device for marking a straight line which is used in combination with an apparatus employed for at least one of leveling and squaring. The device includes housing and a laser module which is mounted within the housing for emitting a visible laser beam therefrom. A power source is mounted within the housing and is coupled to the laser module. A switch is coupled to the laser module and to the power source and is manually operable from an exterior surface of the housing for selectively operating the laser module. A spring clip is provided for releasably mounting the housing to such apparatus.

### CROSS-REFERENCE TO RELATED APPLICATIONS

This application is related to and claims priority from Provisional Patent Application Ser. No. 60/724,488 filed Oct. 7, 2005.

### FIELD OF THE INVENTION

The present invention relates, in general, to line marking devices and, more particularly, this invention relates to a device for marking a straight line in combination with an apparatus for at least one of leveling and squaring which is used by carpenters, roofers and other tradesmen.

### BACKGROUND OF THE INVENTION

As is generally well known, carpenters, roofers and other tradesmen use measuring and leveling devices such as carpenter's squares, speed squares, levels and the like to define and mark a straight line. At times, such straight line must be extended beyond the boundary of such measuring and leveling devices and requires repetitive repositioning of the device in order to mark the complete straight line. Such task may be frustrating and time consuming to accomplish.

Efforts have been made to alleviate the problems associated with marking the straight line which extends beyond the boundary of the measuring and leveling devices. U.S. Pat. No. 6,230,416 issued to Trigilio and U.S. Pat. No. 5,894,675 issued to Cericola disclose a speed square with a built-in laser device for generating a straight line beyond the boundary of such speed square. U.S. Pat. No. 5,966,826 issued to Ho, U.S. Pat. No. 5,713,135 issued to Acopulos and U.S. Pat. No. 5,531,031 issued to Green disclose various elongated leveling devices which incorporate built-in laser devices for marking straight line beyond the length of such leveling devices. However, use of the available prior art devices for marking straight line beyond the boundary of such device either requires a duplication of the conventional measuring and leveling devices owned and presently used by various tradesmen or a discontinued use of such conventional devices. Such condition is unacceptable to many due to increased storage and cost considerations.

### SUMMARY OF THE INVENTION

The invention provides a device for marking a straight line which is used in combination with an apparatus employed for at least one of leveling and squaring. The device includes a housing. A laser module is mounted within the housing for emitting a visible laser beam therefrom. A power source is mounted within the housing and is coupled to the laser module. A switch is coupled to the laser module and to the power source and is manually operable from an exterior surface of the housing for selectively operating the laser module. A spring clip is provided for releasably mounting the housing to such apparatus.

### OBJECTS OF THE INVENTION

It is, therefore, one of the primary objects of the present invention to provide a device for marking a straight line.

Another object of the present invention is to provide a device for marking a straight line which is used in combination with conventional marking and leveling devices such as carpenter's squares, speed squares, levels and the like.

Yet another object of the present invention is to provide a device for marking a straight line which employs a laser device for generating a visible laser beam.

A further object of the present invention is to provide a device for marking a straight line which does not require use of tools for attachment to such conventional marking and leveling devices.

Yet a further object of the present invention is to provide a device for marking a straight line which is simple to use.

An additional object of the present invention is to provide a device for marking a straight line which is economical to manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a device of the present invention for marking a straight line which is illustrated in combination with a carpenter's square;

FIG. 2 is a cross-sectional view of the device of FIG. 1;

FIG. 3 is a block diagram of the device of FIG. 1; and

FIG. 4 is a planar view of the device of FIG. 1, particularly illustrating a laser beam angle positioning means and leveling means of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

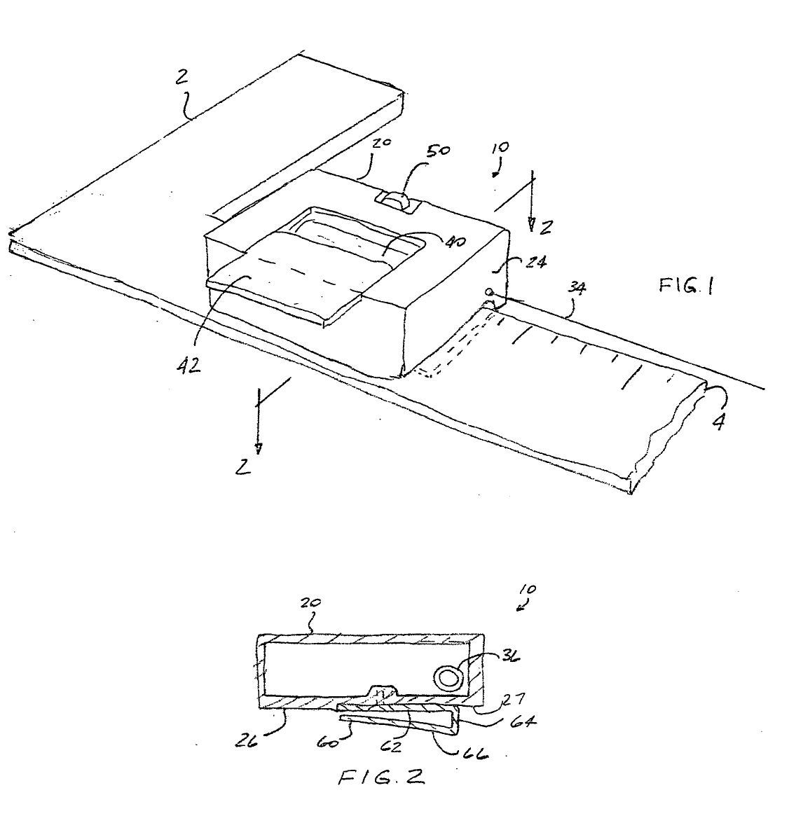

Reference is now made, to FIGS. 1-4, wherein there is shown a device, generally designated as 10, for marking a straight line. The device 10 is used in combination with an apparatus 2 employed for at least one of leveling and squaring. The present invention will be described in combination with a well known carpenter's square 2 which is shown in FIG. 1.

The device 10 includes a housing 20 having a predetermined, preferably rectangular, shape. The presently preferred material of the housing 20 is plastic.

There is means, generally designated as 30 which is mounted within the housing 20 for emitting a visible laser beam 34 therefrom. Such laser means 30 may be of any well known devices capable of emitting a collimated laser beam 34. Preferably, the laser means 30 includes a self-contained laser module 32 of the type disclosed in U.S. Pat. No. 5,121,188 issued on Jun. 9, 1992 to Patridge et al. The disclosure of U.S. Pat. No. 5,121,188 is incorporated into this document by reference thereto. Briefly, such self-contained laser module 32 includes a diode laser (not shown) and a driver circuit (not shown) which are disposed within the cylindrical housing 36 which forms a first electrical contact. The first end of the housing 36 includes a lens positioned to emit the collimated laser beam 34. The opposed second end of the housing 36 includes a second electrical contact positioned to contact a DC power supply. According to the presently preferred embodiment of the invention, the laser module 32 is generally positioned within the housing 20 to align the laser beam 34 being emitted from the side edge 24 of such housing 20 with an edge 4 of the carpenter's square 2.

There is a power source 40 which is mounted within the housing 20 and which is coupled to the second end of the laser module 32. Preferably, the power source 40 is at least one battery 40 for providing DC voltage to the driver circuit (not shown) and diode laser (not shown). It is further preferred that the at least one battery 40 is mounted behind a cover 42 which is detachably secured to a predetermined portion of the housing 20 and is best illustrated in FIG. 1 as being in a partially open position.

In order to selectively operate the laser module 32 and to extend the life of the at least one battery 40, the device 10 includes a switch means 50 which is electrically coupled to such laser module 32 and such at least one battery 40 and which is manually operable from an exterior surface of the housing 20. By way of example in FIGS. 1 and 3, the switch means 50 is lustrated as a sliding type switch 50 which is movable between a first position 52 for activating the laser module 32 and a second position 54 for deactivating such laser module 32.

The device 10 further includes means 60 for releasably mounting the housing 20 to such carpenter's square 2. In the presently preferred embodiment of the invention, the mounting means 60 includes a clip member 60 which is manufactured from a spring steel material and which is attached to a bottom surface 26 of the housing 20 for caging a portion of such carpenter's square 2 therebetween and for applying a predetermined pressure onto such caged portion of such carpenter's square 2. The thickness of such clip member 60 is about 0.020 inches. Essentially, the clip member 60 is formed similar to a well known U-shaped clip (not shown) used for attaching a measuring tape to a belt. Accordingly, the clip member 60 includes a first portion 62 being attached to the bottom surface 26 of the housing 20, preferably in a recessed fashion within a cavity 27 formed in such bottom portion 26, a second portion 64 which extends outwardly from the first portion 62 and a third portion 66 which extends from the second portion 64 toward the first portion 62 and which is biased thereto.

In use, the housing 20 is simply attached to the portion of the carpenter's square 2 by simply caging such portion between the bottom surface 26 of the housing 20 and the third portion 66 of the clip member 60 which exerts a predetermined pressure onto such portion of the carpenter's square 2 for positively retaining the device 10 thereon. It will be appreciated that the attachment of the device 10 by way of the clip member 60 does not require use of hand or power tools. The clip member 60 also enables attachment of the device 10 to carpenter's square 2 which is made form various materials including, plastic, aluminum, steel and wood. Advantageously, the second portion 64 of the clip member 60 may be positioned for providing a positive stop of the device 10 attached to the carpenter's square 2 as well as for aligning the laser beam 34 with the edge 4 of such carpenter's square 2. After attaching the device 10, the user simply moves the switch means 50 to the first position 52 in order to activate the laser module 32 and emit the laser beam 34 beyond the length of the edge 4. The user can then simply mark a reference point and mark the straight line with chalk or mark the straight line directly by using the laser beam 34. The user than moves the switch means 50 to the second position 54 in order to deactivate the laser module 32 and discontinue emission of the laser beam 34. If required, the device 10 can be easily removed from the carpenter's square 2 and stored remotely.

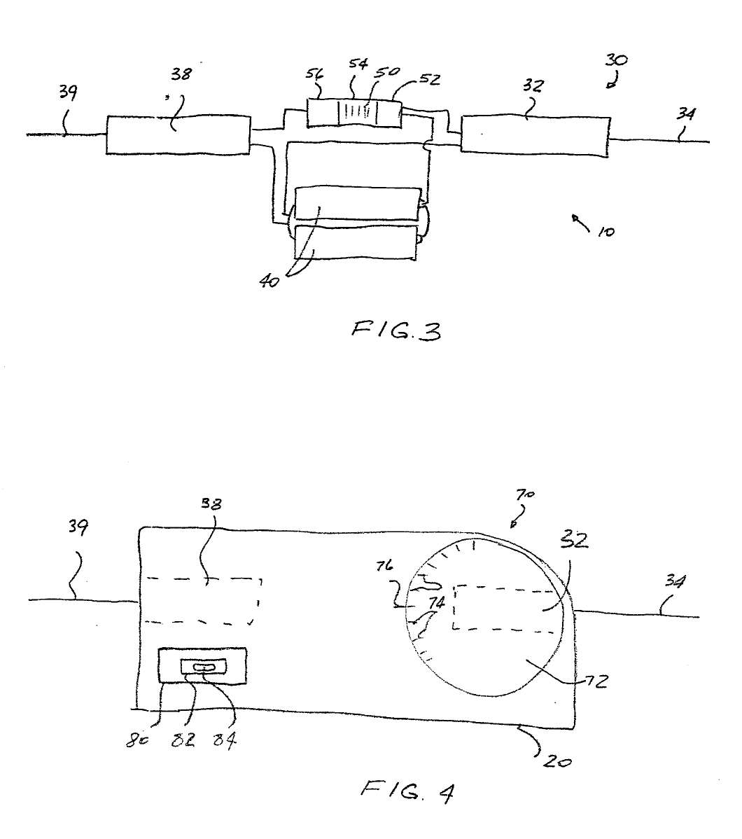

Now in reference to FIG. 4, the present invention contemplates for the device 10 to include means, generally designated as 70, for incrementally and variably positioning the visible laser beam 34 through a range of about 0 degrees to about 90 degrees relative to the edge 4. Accordingly, such laser beam positioning means 70 includes a body 72 which is mounted for rotation within the housing 20 and wherein the laser module 32 is mounted within the body 72. Reference markings 74, 76 are cooperatively formed in the body 72 and in the housing 20 respectively for determining an angle of the laser beam 34. Such laser beam positioning means 70 may be of the type disclosed in U.S. Pat. No. 5,531,031 and its disclosure is incorporated into this document by reference thereto.

It is further contemplated that the device 10 may be adapted with a second laser module 38 for emitting a second visible laser beam 39 in a direction which is opposed to a direction of the visible laser beam 34 emitted by the laser module 32. It is presently preferred that such first laser module 32 and the second laser module 34 are substantially identical. When the second laser module 38 is provided, the switch means 50 will be adapted with a third position 56 enabling the user to selectively activate one of the pair of laser modules 32, 38 depending on the desired direction of marking the line relative to the carpenter's square 2 and further activate such pair of laser modules 32, 38 independently from each other.

It will be appreciated that the use of the second laser device 38 eliminates the need to reposition either the device 10 on the edge 4 or to reposition the carpenter's square 2.

Additionally, the device 10 may be provided with at least one conventional rectangular level element 80 which is mounted within the housing 20 and which is viewable from a front surface thereof. The level element 80 includes a level tube 82 which is filled with a liquid having a movable air bubble 84 for level measuring purposes as is well known in the art. It would be appreciated that the level element 80, which is in FIG. 4 for leveling in a horizontal direction, may be positioned for leveling in a vertical direction or a second level element 80 may be added for leveling in both horizontal and vertical directions.

Although the present invention has been shown in terms of the device 10 used in combination with the carpenter's square, it will be apparent to those skilled in the art, that the present invention may be applied to other devices for leveling and marking such as speed squares, levels and straight edges by simply modifying the construction of the attachment means 60 when required and positioning the laser beam means 30 within the housing 20 for alignment with a respective edge of such devices.

Furthermore, any well known switch types may be employed for selectively operating the laser beam means 30. For example, a pushbutton type switch may be used in the present invention.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. In combination with an apparatus employed for at least one of leveling and squaring, a device for marking a straight line, said device comprising:
(a) a housing having a predetermined shape;
(b) means which is mounted within said housing for emitting at least one visible laser beam therefrom;
(c) a power source which is disposed within the housing and which is coupled to said laser beam means;
(d) a switch means which is coupled to said laser beam means and said power source and which is manually operable from an exterior surface of said housing for selectively operating said laser beam means;
(e) means for releasably mounting said housing to such apparatus.

2. The device, according to claim 1, wherein said laser beam means includes a diode laser capable of emitting a collimated laser beam.

3. The device, according to claim 1, wherein said device includes a pair of diode lasers for emitting a pair of visible laser beams and wherein a direction of one of said pair of visible laser beams is opposed to a direction of a second one of said pair of visible laser beams.

4. The device, according to claim 3, wherein said switch means is adapted for selectively and independently operating each of said pair of diode lasers.

5. The device, according to claim 1, wherein said device includes means for incrementally and variably directing said visible laser beam through a range of about 0 degrees to about 90 degrees from a predetermined edge of said housing.

6. The device, according to claim 5, wherein said laser beam directing means includes a body which is mounted for rotation within said housing and wherein said laser beam means is mounted within said body.

7. The device, according to claim 6, wherein said device further includes reference markings cooperatively formed in said body and in said housing for determining an angle of said laser beam.

8. The device, according to claim 1, wherein said releasable mounting means includes a clip member which is manufactured from a spring steel material and which is attached to a bottom surface of said housing for caging a portion of such apparatus between said bottom surface of said housing and between a predetermined portion of said clip member for applying a predetermined pressure to such caged portion of such apparatus.

9. The device, according to claim 8, wherein said clip member has a thickness of about 0.020 inches.

10. The device, according to claim 8, wherein a second predetermined portion of said clip member is employed for aligning said laser beam with an edge of such apparatus.

11. The device, according to claim 1, wherein said power source is at least one battery.

12. The device, according to claim 1, wherein said power source is mounted behind a cover which is detachably secured to a predetermined portion of said housing.

13. The device, according to claim 1, wherein said device further includes at least one bubble level means which is mounted within said housing and which is viewable from a front surface thereof.
